(19) United States
(12) Patent Application Publication
(10) Pub. No.: US 2004/0107019 A1
(43) Pub. Date: Jun. 3, 2004

(54) Automated rapid prototyping combining additive and subtractive processes

(76) Inventors: Shyam Keshavmurthy, Ann Arbor, MI (US); Judy Ann Carmein, Ann Arbor, MI (US); Dawn White, Ann Arbor, MI (US)

Correspondence Address: John G. Posa, Gifford, Krass, Groh, Sprinkle,, Anderson & Citkowski, P.C., 280 N. Old Woodward Ave., Suite 400, Birmingham, MI, 48009-5394, US

(21) Appl. No.: 10/623,330

(22) Filed: Jul. 18, 2003

Related U.S. Application Data
(60) Provisional application No. 60/396,873, filed on Jul. 18, 2002.

(51) Int. Cl. G06F 19/00

(52) U.S. Cl. 700/118

(57) ABSTRACT

Additive and subtractive manufacturing processes are combined to produce objects having a desired geometry specified by a computerized description. According to the invention, a software system is provided which is capable of creating both additive and subtractive toolpaths, and automatically distinguishing between regions in which addition and subtraction must occur. The additive manufacturing aspect may include solid-state or fusion welding processes of all types (including but not limited to, arc welding, laser welding, resistance welding, friction welding, friction stir welding, ultrasonic welding, laser cladding, plasma welding), laser material deposition, metal spraying, adhesive bonding, vapor or electrochemical deposition and other processes not listed which may suggest themselves to those knowledgeable in the field. The subtraction aspect of the invention may include, but is not limited to milling and various types of cutting tools suited thereto, lasers, knives, hot wires, arc cutters, plasmas cutters, and other such methods of cutting and removing material as may suggest themselves.

### REFERENCE TO RELATED APPLICATION

This application claims priority from U.S. Provisional Patent Application Serial No. 60/396,873, filed Jul. 18, 2002, the entire content of which is incorporated herein by reference.

### FIELD OF THE INVENTION

This invention relates generally to rapid prototyping, rapid tooling and software therefore and, in particular, to apparatus and methods facilitating combined additive and subtractive rapid prototyping processes.

### BACKGROUND OF THE INVENTION

Numerically controlled (NC) and computer numerically controlled (CNC) machining have been known for decades as a means of generating an object possessing some desired geometry from a computerized description. Generally this is done through the automated removal of selected volumes of material from a block of appropriate size.

Additive methods of producing objects possessing a desired geometry from a computerized description were perhaps first described by DiMatteo in 1975. Various other inventors (Hall, Crump, Feygin, etc.) automated such processes and developed as commercial products beginning in the late 1980s. Kulkarni et al. describe an automated method to simplify the build process in additive manufacturing. The automated generation of machine instructions in the case of both of these manufacturing techniques is accomplished by system software, designed to create tool paths for either material removal or addition, depending on the application, which realize the finished article geometry.

However, there are advantages to combining additive and subtractive manufacturing processes in a single automated machine, capable of producing objects having a desired geometry specified by a computerized description. This would require, however, a software system capable of creating both additive and subtractive tool paths, and automatically distinguishing between regions in which addition and subtraction is to occur.

Sachs, in the year 2000 described a method of building complex parts using slabs of material. However, this approach requires the use of fixtures and treatment of each slab as an independent using with a flat plane separation between each slab. De Angelis describes an automated means of depositing material and removing excess material to form the contour, however the software produce from such a scheme would lead to parts being manufactured with stairsteps.

### SUMMARY OF THE INVENTION

This invention recognizes that there are advantages to combining additive and subtractive manufacturing processes in a single automated machine, capable of producing objects having a desired geometry specified by a computerized description. According to the invention, a software system is provided which is capable of creating both additive and subtractive toolpaths, and automatically distinguishing between regions in which addition and subtraction must occur.

The method includes decomposing the desired geometry into regions, which may include but are not limited to layers, volumes, lines, voxels, or other types of features, in which addition and subtraction must occur, depending on the size and nature of the additive feedstock, the size and nature of the subtractive means, and the geometry of the desired end article.

The subtraction aspect of the invention may include, but is not limited to milling and various types of cutting tools suited thereto, lasers, knives, hot wires, arc cutters, plasmas cutters, and other such methods of cutting and removing material as may suggest themselves.

The additive manufacturing aspect may include solid-state or fusion welding processes of all types (including but not limited to, arc welding, laser welding, resistance welding, friction welding, friction stir welding, ultrasonic welding, laser cladding, plasma welding), laser material deposition, metal spraying, adhesive bonding, vapor or electrochemical deposition and other processes not listed which may suggest themselves to those knowledgeable in the field.

Each of these addition or subtraction processes preferably include the definition and creation of characteristic tool path features, which are dependent on the physical nature of the process and its operating parameters, and which allow the software system to accurately model the region that is filled or voided of material during a given a given addition or subtraction operation, to create a constantly accurate geometric model of the part during the build process.

The approach may or may not incorporate defining regions in which material which is not needed in the final component being fabricated, or deposited during an addition process, due to interaction of the nature of the part geometry and the deposition process. Automating the identification and later removal of material is referred to herein as “area clearance.” The volume of material which is deposited and later removed, is identified, modeled geometrically as a defined volume, and toolpaths are created specifically for the removal of this excess. Additive processes which involve the use of pressure to create a bond between previously deposited material and additional material increments are most likely to require such operations, and may include but are not limited to adhesive bonding, ultrasonic welding, friction welding and resistance welding.

Overall, the invention makes possible the additive manufacturing metal parts and other objects that do not have stairsteps, witness lines or other surfacial artifacts. At the same time, the approach retains all of the advantages of additive methods, such as allowing the fabrication of features which are either difficult and costly to produce via subtractive methods (deep narrow slots), or altogether impossible to produce using subtractive methods, which are limited to line of sight applications.

Previous approaches to this problem are inferior for one reason or another. Some (e.g., De Angelis) have taught that only the top layer of an additively manufactured part need be subtractively modified to achieve a geometry. This makes it impossible to achieve the first object of the invention; namely, eliminating the stairstepping and witness lines associated with layer-based additive manufacturing such as that described in his invention. The method of Sachs and Shaikh uses thick sheets that are first subtractively processed to achieve desired profiles, then bonded together. Thick sheets work to minimize the number of witness lines produced. A different method prescribes additively processing an entire component and then “finish machining” the additively processed part (commonly used in production of laser deposited components). However, this adds a great deal of time and cost to the process defeating most of the purpose of additive processing.

By using the methods described in this invention, in which a finishing step, the height of which is controlled and determined by the flute height on the smallest tool required to finish the desired section, the surface finish achievable with 3D machining can be obtained, while retaining the ability of additive processes to produce features and geometries which can be achieved via machining or other subtractive processes.

### BRIEF DESCRIPTION OF THE DRAWINGS

FIG. 1 presents an overview of algorithms in this invention;

FIG. 2 illustrates part and sliced contour at a given height;

FIG. 3 shows a representative slice and its intersection with a tape of a given size;

FIG. 4 shows tessellated models of the tape intersections generated to remove excess material;

FIG. 5 shows a part with negative draft angle along with the tool path generated using the present invention; and

FIG. 6 depicts the recovery and repair of an existing part.

### DETAILED DESCRIPTION OF THE INVENTION

As discussed in the Background, this invention combines additive and subtractive processes is a single system to produce highly accurate, smoothly finished surfaces, even those with deep or narrow features. Such a capability is extremely limited or impossible when subtractive methods alone are used. Tools of very small diameter are required for such operations, and when contacting tools which are very long and narrow are employed, cutting forces will exceed the load required to break the tools. As a result, secondary operations are used to produce these features, adding expense and time to the operations.

Combining additive and subtractive methods allows a “finish as you go” strategy. According to the invention, a software module is included which calculates the maximum feature height on which very small finish tools can be employed. After the height of material has been built and trimmed, a finish path is calculated for the zone, using standard subtractive machining codes, and this is inserted in the program automatically. The finishing is performed, and when completed, the software system automatically returns to building the part using additive means. When sufficient material has again been deposited a finish is incorporated, producing a build/finish/build/finish type of instruction set, which is a claimed method.

In order to perform both additive and subtractive processes sequentially in discrete volumes of material, a means of distinguishing between regions in which addition and subtraction are required, in any given, layer, volume, plan or line type feature is required. Automation of distinguishing between such regions, and defining their size, volume, and location, and determining the order in which additive and subtractive tool paths will be generated and called by the machine instruction set are claimed.

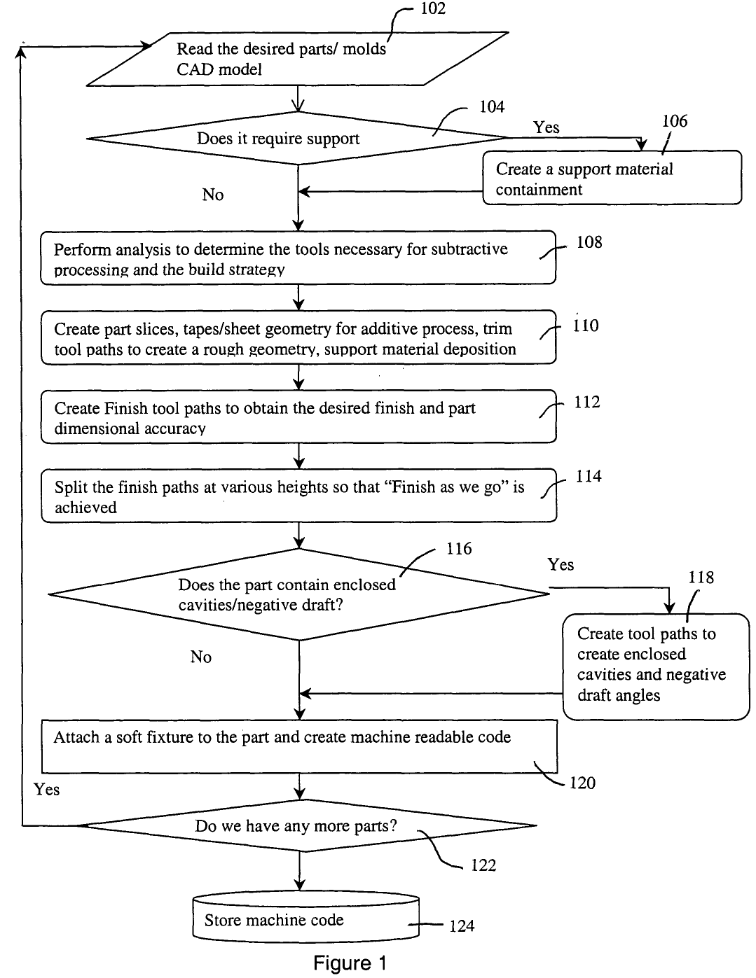

The flowchart shown in FIG. 1 provides an overview of the inventive approach. At block 102, parts, molds and other characteristic information from the CAD model are read in. At block 104, the question is asked whether the model requires support material. If so, support material containment is created at block 106. If not, control is returned to block 108 where an analysis is performed to determine the tools necessary for the subtractive processing aspect, and to construct or build strategy.

At step 110, part slices, tape/sheet geometry and so forth are created for the additive process, along with trim tool pass to create a rough geometry in support of material deposition. At block 112, finish tool paths are created to obtain the desired finished part having the requisite dimensional accuracy.

At block 114, the finished paths are split at various heights to implement a “finish as you go” approach according to the invention. At step 116, the question is asked whether the desired part contains enclosed cavities or a negative draft. If so, at step 118, tool paths are created to enclose the cavities and the negative draft angles. Control is returned to block 120, where a soft fixture is attached to the part and used to create machine-readable code. If more parts need to be created, referring to query 122, control is returned to block 102. If not, machine code for the particular part is stored at 124.

The various substeps associated with the overall process will now be described with reference to other diagrams. As a particular example, to create a part using automated ultrasonic consolidation, the following steps are important:

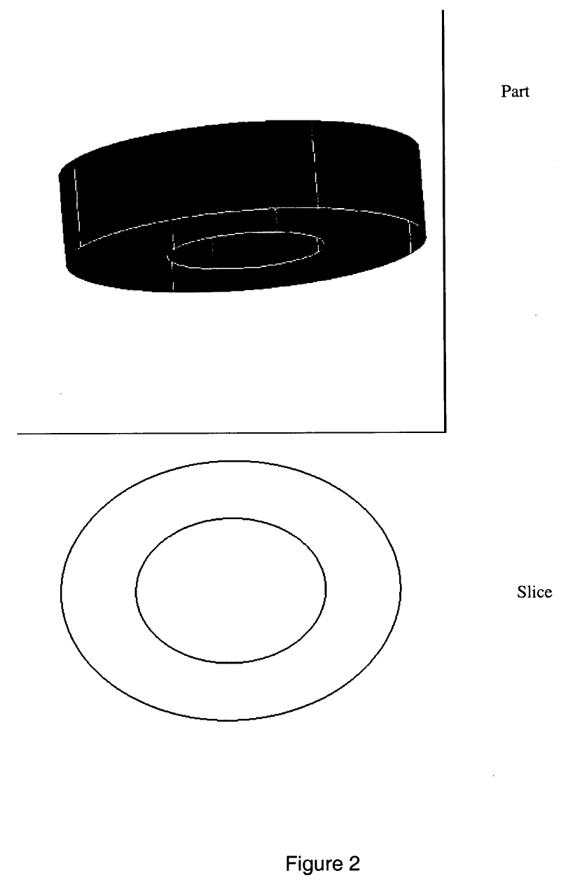

1) Create the part slice as shown in FIG. 2.

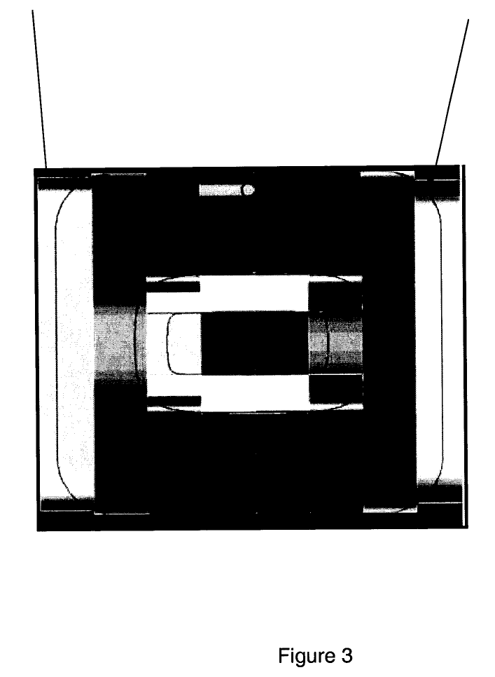

2) Create the intersection between the tape and the sliced boundary below the desired level as shown in FIG. 3

3) Using a datum line create rays and calculate the width of a ray between the points of intersection.

4) Check if the ray is in material

5) Create a linked list of widths of these rays for each tape.

6) Use a hierarchical data structure to store the width information

7) Translate the width information into pressures by querying the width information below the welded region.

8) Manipulate the weld pressure dependent on the shape of the intersection.

9) Convert the weld pressure values to CNC machine-readable commands.

This algorithm used to create the area clearance involves following steps:

1) Compare the slice at given level with a slice from the region preceding it.

2) If the two slices have same number of points and all the points between the two slices match, then proceed to the next slice.

3) If the slices from step 2 are different, then create an intersection between the tape and the slice that is preceding the candidate slice.

4) Check if the intersection generated in step 3 has enough points to create tessellated models that match the part contour. If needed, fill additional points to the intersections to generate a tessellated model that results in continuous contour tool path.

5) Create a tessellated model of the tape intersection preferably using a Delaunay triangulation technique.

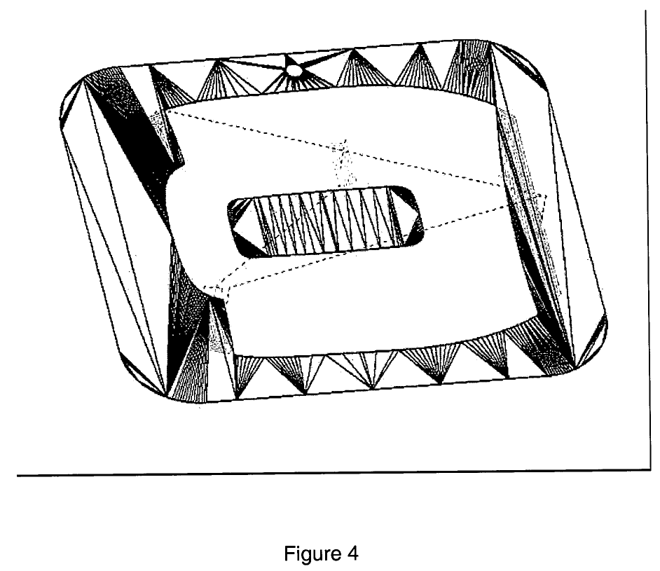

6) Use the tessellated model from step 4 as the block to be machined and the slice at the candidate level as a guide and create a tool path that would remove excess material as shown in FIG. 4

7) Continue to step 1 for the next slice

The ‘finish as you go’ strategy then proceeds as follows:

1) Create a finish path treating the part as a single unit similar to a top down machining process.

2) Create a set of planes along the height of the part that defines a unit finish operation. This could include a single slice or multiple slices. The allowable flute length of a selected tool determines this height.

3) Using the tool path from step 1 limit the tool paths between the planes defined by step 2, with an addition of a top fraction of a tool path from unit below. This overlapping allows blending of tool paths from two sections, thus resulting in a seamless machined surface.

The creation of internal cavities and channels involves the following steps:

1) Create slices of a given model including internal cavities.

2) Create pattern templates from the slices produced in the above steps

3) Use the pattern templates along with a machining block that corresponds to the slice thickness to create a profile path so that the top down machining process would not account for the material above the slice.

4) Use this tool path only to machine but not to calculate the weld pressures so that a cavity could be covered by the layers above.

When multiple parts are built it is standard practice to provide different work-holding fixtures for each of the part. In this regard, this invention allows multiple parts to be built with soft fixturing wherein a mechanical holder is not necessary. This is accomplished through following steps:

1) A different frame of reference is set up for each of the objects to be produced for ultrasonic consolidation

2) The parts are processed for additive-subtractive rapid prototyping using the methods described under sections 1 and 2.

3) When the CNC motions are generated, the part built steps are interlaced that a certain set of operations are completed before adding new material. These steps are done for each frame of reference.

4) Since these frames of reference are automatically set, a user of the CNC machine has to electronically set the desired part positions.

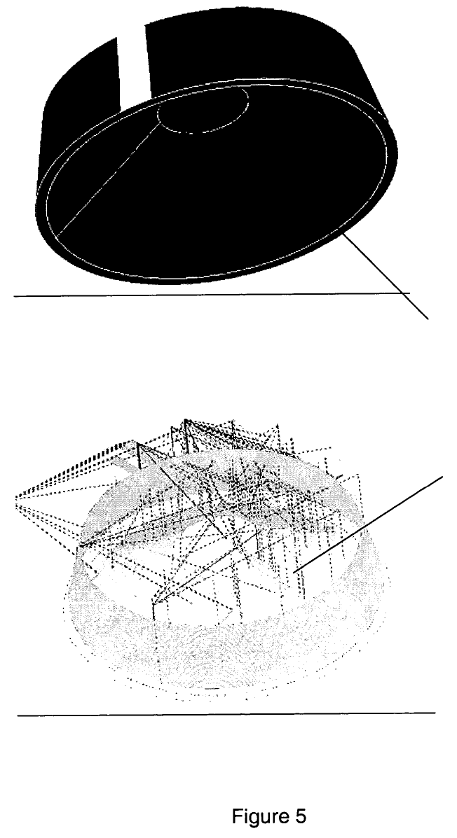

Top-down machining process do not allow negative draft angles, as shown in FIG. 5 to be machined, because of the tool and work piece collision. However, this invention presents a model as if it were a slice from the whole model, thus eliminating the part and tool collision issue. FIG. 4 shows a part with negative draft angle and the tool paths. Thus an algorithm that creates tool paths for an additive-subtractive process can be used to machine negative draft angles.

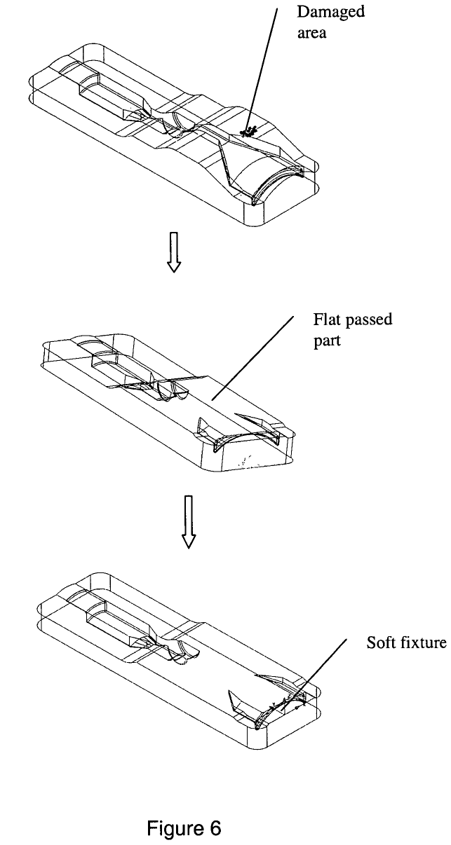

General top-down machining and additive machining processes also do not allow recovery of a part during the process of a part build if there were to be damage to the part build. This invention allows users to recover and repair pre-existing parts in case of damage. FIG. 6 shows the scheme for recovery and rebuild of a damaged part using the following approach:

1) A set of special codes is set-aside for each of the operation along with the part identification number.

2) The CNC programs identify these codes beginning of each operation.

3) An operation called as flat pass is generated, that qualifies an asked height. This CNC tool path is generated using an envelope that encloses a part at a given height.

4) A soft fixture is setup to identify the height at which the flat pass process will end.

5) Using the soft fixture established in step 4, a part can be recovered using methods 1 through 6.

6) For an existing part, the steps from 1 to 5 are used in addition to user assigning a soft fixture and identifying the areas of support.

The following are the steps used for creating an automated support material containment:

1) A bounding box is first calculated for a CAD model, which can be either a part or a mold.

2) The bounding box is then converted to a solid model

3) Another solid model is then created that is larger than the solid created in step 2

4) The solid from step 2 is subtracted from solid from step 3.

5) Fillet s of appropriate radii are added to the resultant solid from step 4.

6) The solid from step 5 is then combined with the CAD model and saved for slicing.

For certain types of features, in particular those in which cantilevered features, or very large overhangs exist, a variation on the above automated support material containment system may be desirable, including the generation of a conformal support material containment structure. The following steps would be used for creating such a conformal support material containment:

1) Create a bounding rectangle.

2) Create slices of the negative draft surfaces.

3) Skip the area clear operation from the build. This generates a welded supporting structure with a small clearance between itself and the part, in which the support material can be dispensed.

4) Continue the build as set forth in subsection 1.

Having described our invention, we claim:

1. An automated manufacturing method, comprising the steps of:
receiving a description of an object to be fabricated having a desired geometry;
identifying regions in which at least one automated material addition process and at least one automated material subtraction process should occur to fabricate the object in accordance with the description;
generating toolpaths associated with the material addition and subtraction processes; and
fabricating the object in accordance with the toolpaths.

2. The method of claim 1, wherein the regions are layers, volumes, lines or voxels.

3. The method of claim 1, wherein the automated material subtraction process includes milling or the use of lasers, knives, hot wires, arc cutters, or plasmas cutters.

4. The method of claim 1, wherein the automated material addition process includes solid-state or fusion welding, laser material deposition, metal spraying, or adhesive bonding.

5. The method of claim 1, wherein:
the automated material addition process includes welding; and
calculating weld pressure, temperature, excitation amplitude or frequency to fabricate the object in accordance with the description.

6. The method of claim 1, wherein the subtractive process does not require the use of work holding fixtures or fiducial marking.

7. The method of claim 1, further including the step of soft fixturing multiple parts.

8. The method of claim 1, wherein:
the automated material addition process includes ultrasonic consolidation; and
calculating consolidation pressure, temperature, excitation amplitude or frequency to fabricate the object in accordance with the description.

9. The method of claim 1, further including the step of blending the regions to eliminate seams that would be generated due to the subtractive process used.

10. The method of claim 1, further including the step of creating enclosed and overhanging features using the additive or subtractive manufacturing processes, or a combination thereof.

11. The method of claim 1, further including the steps of:
identifying changes in the desired geometry;
removing excess material to achieve the desired geometry.

12. The method of claim 1, further including the steps of:
analyzing the description of the object to be fabricated to recognize the tool size, heated wire or laser beam size required to fabricate the object in accordance with the description.

13. The method of claim 1, further including the step of using a slab generation technique without the use of a tessellated model.

14. The method of claim 1, further including the step of fabricating the object vertically or horizontally in accordance with the description.

15. The method of claim 1, further including the step of generating enclosed cavities within the object during the fabrication thereof.

16. The method of claim 1, further including the step of calculating undercut tool paths without tool or object reorientation.

17. The method of claim 1, further including the step of repairing an existing mold or other object.

18. The method of claim 1, wherein a tool path associated with additive processing is based on the nature of the additive process used.

19. The method of claim 1, further including the step of incorporating negative draft angles using the additive or subtractive processing.

20. The method of claim 1, further including the steps of:
generating finish paths that are dependent on the flute height of the smallest tool required; and
determining what Z height should be deposited and trimmed prior to finishing based on the flute height of the smallest tool required.

21. The method of claim 1, wherein:
certain features are deposited with excess stock based on feature geometry; and
removing material to enhance the deposition process, or speed the build rate of the object.

22. The method of claim 1, further including the step of generating a conformal support material containment structure.
